(19) United States
(12) Patent Application Publication
(10) Pub. No.: US 2011/0308770 A1
(43) Pub. Date: Dec. 22, 2011

(54) HEAT DISSIPATION STRUCTURE OF LED HEAD LAMP

(75) Inventor: Kwang Woon Cho, Yongin-si (KR)

(73) Assignees: Kia Motors Corporation, Seoul (KR); Hyundai Motor Company, Seoul (KR)

(21) Appl. No.: 12/917,208

(22) Filed: Nov. 1, 2010

(30) Foreign Application Priority Data
Jun. 18, 2010 (KR) 10-2010-0058052

(51) Int. Cl. F28D 15/00; G06F 1/20

(52) U.S. Cl. 165/104.11; 165/121

(57) ABSTRACT

A heat dissipation structure of an LED head lamp is provided which includes heat dissipation fins mounted on a lower portion of an LED module, a cooling duct mounted on a lower portion of the heat dissipation fins, an air inflow unit making an external air flow into the cooling duct, and an air discharge unit discharging the air in the cooling duct to the outside.

### CROSS-REFERENCE TO RELATED APPLICATION

The present application claims priority to Korean Patent Application No. 10-2010-0058052, filed on Jun. 18, 2010, the entire contents of which is incorporated herein for all purposes by this reference.

### BACKGROUND OF THE INVENTION

1. Field of the Invention

The present invention relates to a heat dissipation structure of an LED (“Light-Emitting Diode”) head lamp, and more particularly, to a heat dissipation structure of an LED head lamp, which cools a heat source generated from an LED head lamp through an inflow of external air or dissipates the heat source generated from the LED head lamp to the outside using a suction force through a radiator fan.

2. Description of Related Art

In general, since LED (Light Emitting Diode) has a color temperature of about 5500K and is close to sunlight to greatly reduce eye strain, it has been widely used as a light source of a vehicle head lamp.

Also, since the LED head lamp has a small size, it has a high degree of freedom in design, and is economical due to its semi-permanent lift span.

The LED head lamp, however, generates high heat when its LED elements emit light, and due to this high heat, the efficiency of light emission is greatly lowered.

In order to solve this problem, a heat dissipation device is mounted on the LED head lamp to dissipate the heat source generated from the LED head lamp.

FIG. 1 is a view illustrating a heat dissipation structure of an LED head lamp in the related art.

The LED head lamp heat dissipation structure in the related art, as illustrated in FIG. 1, includes an LED module 20 installed inside a head lamp housing 10, heat dissipation fins 30 installed on a bottom surface of the LED module 20, and a cooling fan 40 installed under the heat dissipation fins 30.

According to the LED head lamp heat dissipation structure in the related art, the heat generated from the LED module 20 is dissipated to the outside through the heat dissipation fins 30 installed on the bottom surface of the LED module 20, and the heat dissipation fins 30 are cooled by the cooling fan 40 to increase the heat dissipation efficiency.

However, the LED head lamp heat dissipation structure in the related art has the problem that the separate cooling fan 40 is mounted as shown in FIG. 2 to necessitate an additional cost, and in the case of using the cooling fan 40 for a long time, the cooling fan 40 is overheated to cause hot wind to blow, and thus the cooling efficiency is lowered.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a heat dissipation structure of an LED head lamp, which makes it possible to remove a cooling fan and cools and dissipates high heat generated from the LED head lamp through an inflow of an external air and to provide a heat dissipation structure of an LED head lamp, which dissipates high heat generated from an LED module by discharging the high heat to the outside using a suction force of a radiator fan.

In one aspect of the present invention, the heat dissipation structure of an LED (“Light-Emitting Diode”) head lamp, may include heat dissipation fins mounted on a lower portion of an LED module, a cooling duct mounted on a lower portion of the heat dissipation fins and including a storage space to receive the heat dissipation fins therein, an air inflow unit connected to a side of the cooling duct to make an external air flow into the cooling duct, and an air discharge unit connected to another side of the cooling duct to discharge the air of the cooling duct to the outside.

The air inflow unit may have an inlet positioned on a front side of a vehicle body and an outlet connected to the side of the cooling duct, wherein the inlet of the air inflow unit may have a diameter that may be larger than that of the outlet of the air inflow unit.

The air discharge unit may have an inlet connected on the other side of the cooling duct and an outlet positioned on a side portion of the vehicle body, wherein an outlet of the air inflow unit and the inlet of the air discharge unit may be positioned to cross each other.

A connection unit may be installed between the cooling duct and a radiator fan installed in a vehicle body, and may have an inlet connected to the other side of the cooling duct and an outlet positioned on a front portion of the radiator fan.

In another aspect of the present invention, a method of cooling an LED head lamp, may include receiving an external air into a cooling duct through an air inflow unit of a heat dissipation structure and discharging the air of the cooling duct to the outside through an air discharge unit to heat-dissipate the LED head lamp during traveling of a vehicle, and compulsorily discharging the air of the cooling duct through a connection unit to the outside using a suction force of a radiator fan during stopping of the vehicle, wherein the heat dissipation structure may include heat dissipation fins mounted on a lower portion of an LED module, the cooling duct mounted on a lower portion of the heat dissipation fins and including a storage space to receive the heat dissipation fins therein, the air inflow unit connected to a side of the cooling duct to make an external air flow into the cooling duct, the air discharge unit connected to another side of the cooling duct to discharge the air of the cooling duct to the outside, and a connection unit installed between the cooling duct and a radiator fan installed in a vehicle body, and having an inlet connected to the other side of the cooling duct and an outlet positioned on a front portion of the radiator fan.

With the above-described construction of the present invention, the high heat generated from the LED module is cooled by making an external air flow into the LED heat lamp, and thus the heat dissipation efficiency is increased and the manufacturing cost is reduced through the deletion of the cooling fan. Further, the air inside the LED head lamp is discharged out of the LED head lamp using the suction force of the radiator fan, and thus the heat dissipation of the LED head lamp is increased.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a view illustrating a heat dissipation structure of an LED head lamp in the related art.

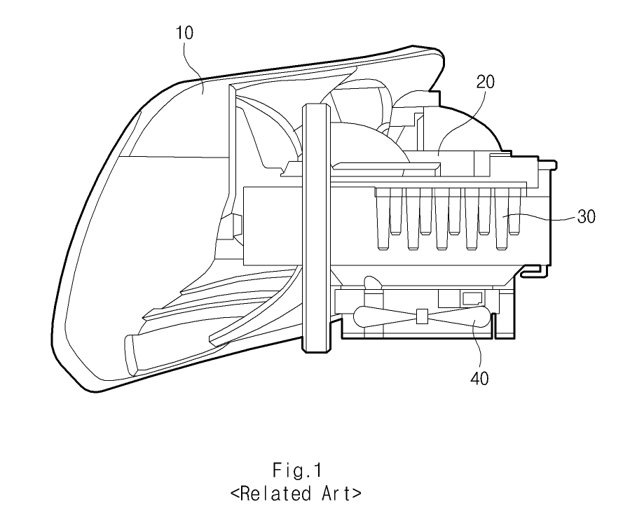

FIG. 2 is a sectional view of a heat dissipation structure of an LED head lamp in the related art.

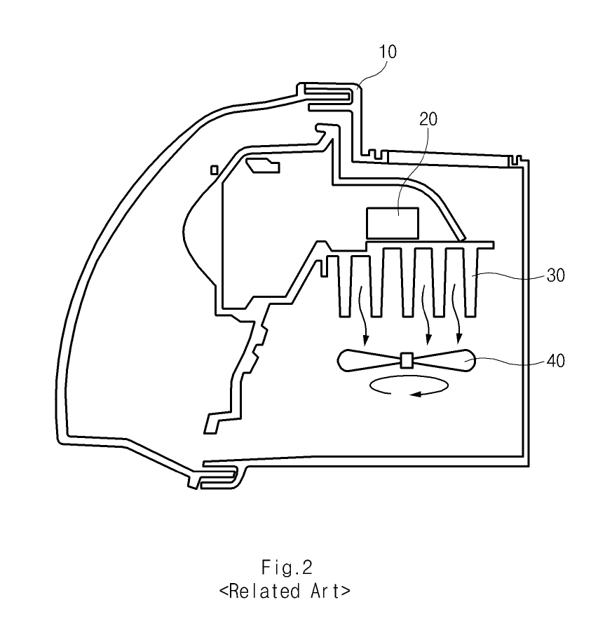

FIG. 3 is a view illustrating a heat dissipation structure of an LED head lamp according to an exemplary embodiment of the present invention.

FIG. 4 is an expanded view of a heat dissipation structure of an LED head lamp according to an exemplary embodiment of the present invention.

FIG. 5 is a sectional view of a heat dissipation structure of an LED head lamp according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

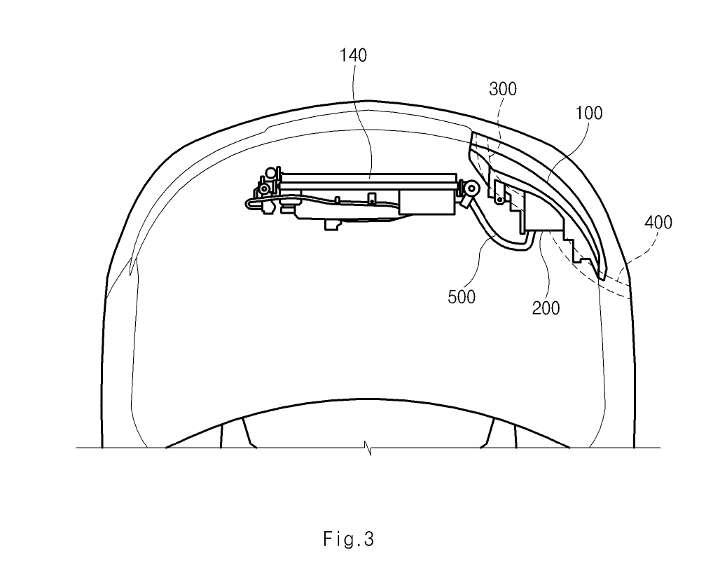

Hereinafter, a heat dissipation structure of an LED head lamp according to an exemplary embodiment of the present invention will be described in detail with reference to FIGS. 3 to 5.

The heat dissipation structure of an LED head lamp according to an exemplary embodiment of the present invention cools high heat generated from an LED head lamp 100 through an inflow of an external air during traveling of a vehicle, and discharges a heat source in the LED head lamp 100 to the outside using a suction force through a radiator fan 140 during stopping of the vehicle. Accordingly, the cooling efficiency of the LED head lamp 100 is increased, and the manufacturing cost is reduced through deletion of a separate cooling fan.

As illustrated in FIG. 3, the heat dissipation structure of an LED head lamp according to an exemplary embodiment of the present invention includes an LED head lamp 100, a cooling duct 200 mounted in the LED head lamp 100, an air inflow unit 300 that is a path through which an external air flows into the cooling duct 200, and an air discharge unit 400 that is a path through which the air in the cooling duct 200 is discharged to the outside.

Hereinafter, the heat dissipation structure of the LED head lamp according to an exemplary embodiment of the present invention will be described in more detail.

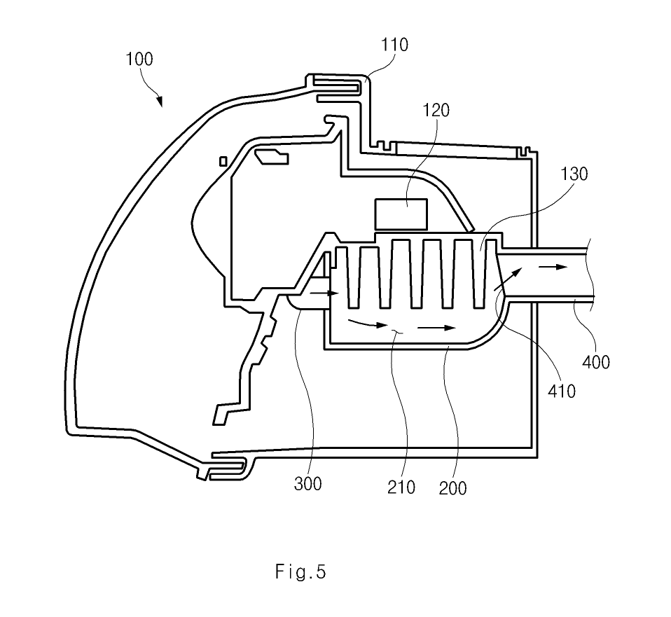

The LED head lamp 100, as illustrated in FIG. 5, includes a head lamp housing 110 mounted on front left and right sides of a vehicle body, an LED module 120 mounted inside the head lamp housing 110 and having a plurality of LED elements mounted thereon to emit light when a power is applied thereto, heat dissipation fins 130 provided in close contact with a bottom portion of the LED module 120 to dissipate high heat generated from the LED module 120 to the outside, and a lens (not illustrated) mounted in front of the head lamp housing 110 to diffuse the light emitted from the LED module 120 in front of the vehicle.

That is, a user can secure a visual field using the light emitted from the LED module 120 of the LED head lamp 100 when the vehicle passes through a dark place. In this case, the LED elements of the LED module 120 generate high heat, and this high heat of the LED elements is dissipated in all directions through the heat dissipation fins 130.

The cooling duct 200 is to cool the heat dissipation fins 130 through an inflow of cold air from the outside. The cooling duct 200 has a storage space 210 for storing air therein, and the heat dissipation fins 130 are inserted into and fixed to the upper surface of the storage space 210.

That is, the air flowing into the storage space 210 of the cooling duct 200 becomes in contact with the heat dissipation fins 130 to cool the heat dissipation fins 130.

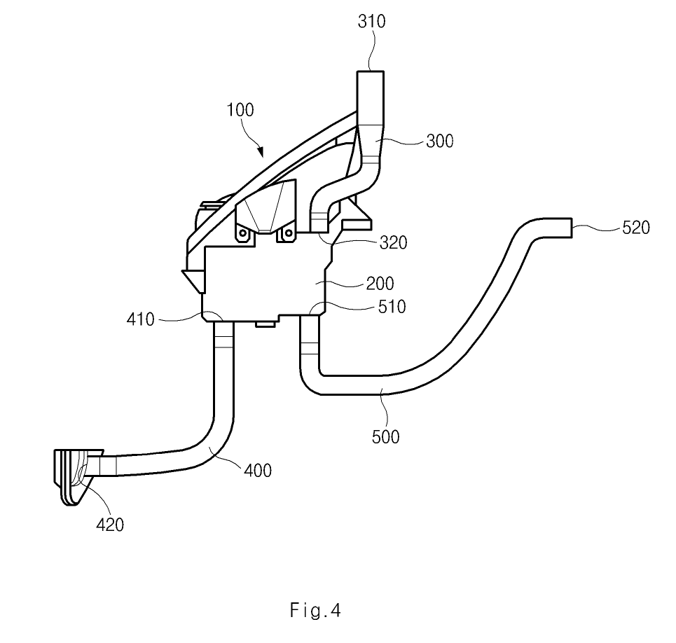

The air inflow unit 300, as illustrated in FIG. 4, is a path through which the external air flows into the storage space 210 of the cooling duct 200, and is formed by a flexible tube. An inlet 310 of the air inflow unit 300 is positioned in front of the vehicle body to make the air blowing to the front of the vehicle body flow into the storage space 210, and an outlet 320 of the air inflow unit 300 is connected to one side of a front surface of the cooling duct 200 to communicate with the storage space 210 of the cooling duct 200.

Here, the inlet 310 of the air inflow unit 300 has a diameter that is larger than that of the outlet 320 of the air inflow unit 300 in order to make the air flow therein more efficiently and to increase the heat dissipation effect through the increase of the air inflow.

That is, the diameter of the air inflow unit 300 is gradually smaller from the inlet 310 to the outlet 320 of the air inflow unit 300 so that the air inflow unit 300 is in the form of a funnel.

Also, on the inlet 310 of the air inflow unit 300, a filter (not illustrated) for filtering foreign substances included in the air may be detachably installed, and through this, the foreign substances is prevented from flowing into the storage space 210 of the cooling duct 200.

During the traveling or stopping of the vehicle, as the air blowing to the front of the vehicle flows into the storage space 210 of the cooling duct 200 through the inlet 310 of the air inflow unit 300, the heat dissipation fins 130 positioned on the upper portion of the storage space 210 is cooled.

The air discharge unit 400 is a path through which the air in the storage space 210, of which the temperature is heightened as the air cools the heat dissipation fins 130, is discharged to the outside, and is formed by a flexible tube. An inlet 410 of the air discharge unit 400 is provided on the other side of the rear surface of the cooling duct 200 to communicate with the storage space 210, and an outlet 420 is positioned on the side surface of the vehicle body to discharge the air stored in the cooling duct 200 through the side surface of the vehicle body.

On the other hand, it is preferable that the outlet 320 of the air inflow unit 300 that is connected to the cooling duct 200 and the inlet 410 of the air discharge unit 400 are not in the same position, i.e. are positioned to cross each other. This is to make the air passing through the air inflow unit 300 effectively exchange heat with the heat source discharged from the heat dissipation fins 130 as the air circulates in the cooling duct 200 for a predetermined time, and then to make the air discharged quickly through the air discharge unit 400.

Also, a partition may be additionally formed in zigzag inside the cooling duct 200, and this partition is to increase the heat exchangeability by increasing the stay time of the external cold air flowing into the cooling duct 200.

Hereinafter, the operation and effect of the heat dissipation structure of an LED head, lamp as constructed above according to an exemplary embodiment of the present invention will be described.

During traveling or stopping of the vehicle, the cold wind blowing from the front of the vehicle body flows into the storage space 210 of the cooking duct 200 through the air inflow unit 300, and becomes in contact with the heat dissipation fins 130 to cool the heat dissipation fins 130. Accordingly, the LED module 120 can be heat-dissipated more effectively.

Then, the air that is heated as it contacts the heat dissipation fins 130 is discharged to the side surface of the vehicle body through the air discharge unit 400.

By repeating the process of cooling the heat dissipation fins 130 provided in the cooling duct 200 using the air flowing through the air inflow unit 300 and discharging the inflow air through the air discharge unit 400, the LED head lamp 100 can be heat-dissipated more effectively, and thus a cooling fan for compulsorily cooling the heat dissipation fins 130 can be deleted.

On the other hand, the LED head lamp heat dissipation structure including the cooling duct 200, the air inflow unit 300, and the air discharge unit 400 can increase the heat dissipation since the air flow is increased during the traveling of the vehicle, but during the stopping of the vehicle, the air flow is reduced and the heat dissipation is lowered.

In order to solve this problem, a connection unit 500 may be additionally installed to make an external air quickly flow into the storage space 210 of the cooling duct 200 by compulsorily discharging the air having flowed into the storage space 210 of the cooling duct 200 using an air suction force through a rotating force of a radiator fan 140 that is in a rotating state during starting of the vehicle.

On the other hand, since the radiator fan 140 is a known technology, which is mounted on the front surface of the vehicle body to cool an engine oil and mission oil that circulate in the engine using the wind power, the detailed description thereof will be omitted.

That is, the connection unit 500 is a path for connecting the radiator fan 140 and the cooling duct 200, and has an inlet 510 connected to the side portion of the cooling duct 200 to communicate with the storage space 210 and an outlet 520 provided on one side of the front surface of the radiator fan 140.

When the radiator fan 130 is rotated, a suction force is generated in front of the radiator fan 130, and by this suction force of the radiator fan 130, the air inside the cooling duct 200 that is connected to the connection unit 500 is compulsorily sucked to be discharged out of the connection unit 500, and the external air, as much as the air discharged through the connection unit 500, flows into the cooling duct 200 through the air inflow unit 300 to cool the heat dissipation fins 130, and thus the heat dissipation of the LED module 120 can be increased.

As described above, according to the heat dissipation structure of an LED head lamp according to an exemplary embodiment of the present invention, the air flows into the cooling duct 200 through the air inflow unit 300 during the traveling of the vehicle, and the air, having flowed into the cooling duct 200 is discharged to the outside through the air discharge unit 400 to heat-dissipate the LED head lamp 100. Accordingly, the heat dissipation of the LED head lamp 100 is increased. Further, during the stopping of the vehicle, the air inside the cooling duct 200 that is connected to the connection unit 500 is compulsorily discharged to the outside using the suction force of the radiator fan 140, and thus the heat dissipation of the LED head lamp 100 can be further increased.

For convenience in explanation and accurate definition in the appended claims, the terms “upper”, “lower”, “inner”, “front” and “rear”, are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A heat dissipation structure of an LED (“Light-Emitting Diode”) head lamp, comprising:
heat dissipation fins mounted on a lower portion of an LED module;
a cooling duct mounted on a lower portion of the heat dissipation fins and including a storage space to receive the heat dissipation fins therein;
an air inflow unit connected to a side of the cooling duct to make an external air flow into the cooling duct; and
an air discharge unit connected to another side of the cooling duct to discharge the air of the cooling duct to the outside.

2. The heat dissipation structure of claim 1, wherein the air inflow unit has an inlet positioned on a front side of a vehicle body and an outlet connected to the side of the cooling duct.

3. The heat dissipation structure of claim 2, wherein the inlet of the air inflow unit has a diameter that is larger than that of the outlet of the air inflow unit.

4. The heat dissipation structure of claim 1, wherein the air discharge unit has an inlet connected on the other side of the cooling duct and an outlet positioned on a side portion of the vehicle body.

5. The heat dissipation structure of claim 4, wherein an outlet of the air inflow unit and the inlet of the air discharge unit are positioned to cross each other.

6. The heat dissipation structure of claim 1, wherein a connection unit is installed between the cooling duct and a radiator fan installed in a vehicle body, and has an inlet connected to the other side of the cooling duct and an outlet positioned on a front portion of the radiator fan.

7. The heat dissipation structure of claim 1, wherein the cooling duct includes at least a partition therein to increase stay time of the air therein.

8. A method of cooling an LED head lamp, comprising:
receiving an external air into a cooling duct through an air inflow unit of a heat dissipation structure and discharging the air of the cooling duct to the outside through an air discharge unit to heat-dissipate the LED head lamp during traveling of a vehicle; and
compulsorily discharging the air of the cooling duct through a connection unit to the outside using a suction force of a radiator fan during stopping of the vehicle,
wherein the heat dissipation structure includes:
heat dissipation fins mounted on a lower portion of an LED module;
the cooling duct mounted on a lower portion of the heat dissipation fins and including a storage space to receive the heat dissipation fins therein;
the air inflow unit connected to a side of the cooling duct to make an external air flow into the cooling duct;
the air discharge unit connected to another side of the cooling duct to discharge the air of the cooling duct to the outside; and
a connection unit installed between the cooling duct and a radiator fan installed in a vehicle body, and having an inlet connected to the other side of the cooling duct and an outlet positioned on a front portion of the radiator fan.
